(19) United States
(12) Patent Application Publication
(10) Pub. No.: US 2024/0383385 A1
(43) Pub. Date: Nov. 21, 2024

(54) VEHICLE SEAT FLAP FOR CONCEALING FRAME

(71) Applicant: Lear Corporation, Southfield, MI (US)

(72) Inventors: Martin Olha, Ondavske Matiasovce (SK); Josef Královec, Pilsen (CZ); Kamil Kolaciak, Bielsko-Biala (PL)

(21) Appl. No.: 18/319,698

(22) Filed: May 18, 2023

(51) Int. Cl. B60N 2/60

(52) U.S. Cl. CPC B60N 2/6018

(57) ABSTRACT

An assembly includes a trim cover sized to be received on a seat cushion, whereby a gap is defined between a bottom front edge of the trim cover and a seat frame. A flap has an upper edge connected to the trim cover and a lower edge connectable to the seat frame. The flap conceals the gap. The flap is flexible such that the flap covers the gap when the seat cushion moves between an in-use position and a stowed position.

### TECHNICAL FIELD

This discloses relates to seats and more particularly to a seat flap that conceals seat-frame components located underneath a seat bottom.

### BRIEF DESCRIPTION OF THE DRAWINGS

FIG. 1 illustrates a perspective view of a seat assembly in an in-use position with the flap omitted for illustrative purposes.

FIG. 2 illustrates a side view of the seat assembly in a non-use position.

FIG. 3 illustrates a partial perspective view of the seat assembly in the in-use position and with the flap shown.

FIG. 4 illustrates a front view of the seat assembly with a slide fastener of the flap partially open.

FIG. 5 illustrates a front view of the seat assembly with the slide fastener of the flap closed.

FIG. 6 illustrates a side cross-sectional view of the flap and flap anchor.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

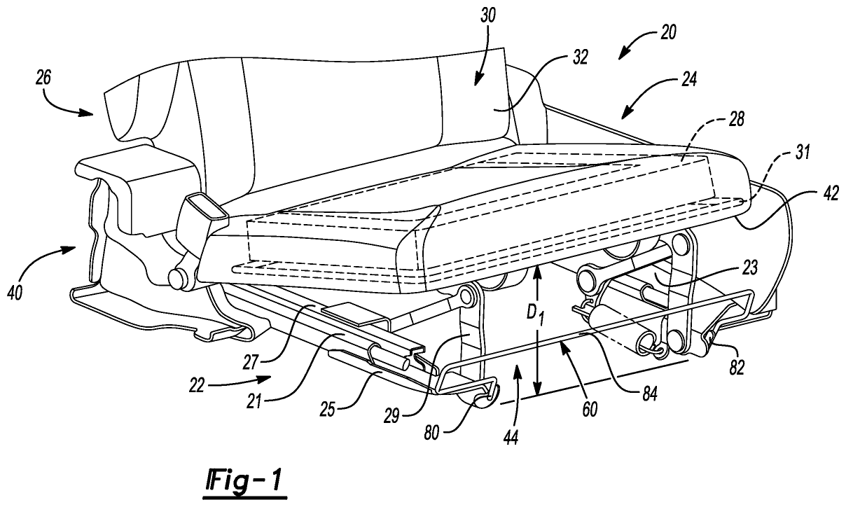

FIG. 1 illustrates a seat assembly 20. The seat assembly 20 may be shaped and sized as a front row driver or passenger seat, a second, third, or other rear row seat, and may include bench-style seats, bucket seats, or other seat styles. Furthermore, the seat assembly 20 may be a non-stowable seat or a stowable seat that may be foldable and stowable in a cavity in the vehicle floor. Additionally, the seat assembly 20 may be configured for use with other non-vehicle applications.

The seat assembly 20 has a frame 22 or other support structure. The seat assembly 20 may include at least a seat bottom 24 and a seat back 26. The seat bottom 24 may be sized to receive a seated occupant and support a pelvis and thighs of the occupant. The seat back 26 may be sized to extend upright from the seat bottom 24 to support a back of the occupant. The seat assembly 20 may additionally have a head restraint (not shown). The seat bottom 24 has a seat bottom cushion 28. The seat back 26 has a seat back cushion 30. The frame 22 may include wire suspension mats or other structure to support the cushions 28, 30 as discussed below.

The frame 22 provides rigid, structural support for the seat components, e.g., the seat bottom 24 and seat back 26, and may be provided as multiple frame members that are moveable relative to one another to provide adjustments for the seat assembly 20. The frame 22 may be formed from a stamped steel alloy, a fiber reinforced polymer, or any suitable material.

The frame 22 may include a pair of longitudinal rails 21 and 23 configured to connect with a floor of the vehicle or other support structure depending upon the application of the seat. Each of the rails 21, 23 may include a lower, stationary portion 25 fixed to the support structure and an upper, movable portion 27 fixed to the seat. The movable portion 27 may slide relative to the stationary portion 25 to adjust the fore-and-aft position of the seat.

The frame 22 may further include a seat pan 31 that supports the seat bottom cushion 28. One or more linkages 29 may connect between the seat pan 31 and the rails 21. The linkages 29 may provide for up-and-down movement of the seat bottom 24 relative to the frame to increase or decrease the height of the seat bottom 24 relative to the floor or other support structure.

One or more trim covers 32 are used to cover the seat bottom cushion 28 and the seat back cushion 30, and provide an exterior seating surface for the seat assembly 20. In one example, the trim cover 32 covers both of the cushions 28, 30. In other examples, separate trim covers (as shown) are provided to cover the seat bottom cushion 28 and the seat back cushion 30. The trim cover 32 may be formed from one or more panels of fabric, leather, leatherette, vinyl, or other material.

The seat cushion 28, seat cushion 30 or both may include foam components or nonfoam components. In one example, the seat cushion is formed solely from a foamed component. Alternatively, the seat cushion is formed solely from a nonfoam component, such that the nonfoam component provides all of the cushioning for the seat component between the frame 22 and the trim cover 32. In other examples, the seating cushion may be formed from a nonfoam component as well as one or more foam components, such as a component formed from molded polyurethane foam, or other nonfoam components. The seating cushion may have the nonfoam and foam components positioned in different regions of the cushion for the seating component, e.g., a central region and side bolster regions.

In one non-limiting example, the nonfoam component of the seating cushion 28/30 is formed by a stranded mesh material, also known as an entangled three-dimensional filament structure. The stranded-mesh material is made from a polymeric mesh having a plurality of integrated polymeric strands. The stranded-mesh material may be made from, for example, a linear low-density polyethylene (LLPDE) material, although other polymers and materials effective to provide the desired properties and functionality are contemplated. The stranded-mesh material may be formed using extruded filaments of linear low-density polyethylene (LLDPE) that are randomly entangled, bent, looped, or otherwise positioned and oriented, and directly bonded to each other to provide a porous mesh structure, for example.

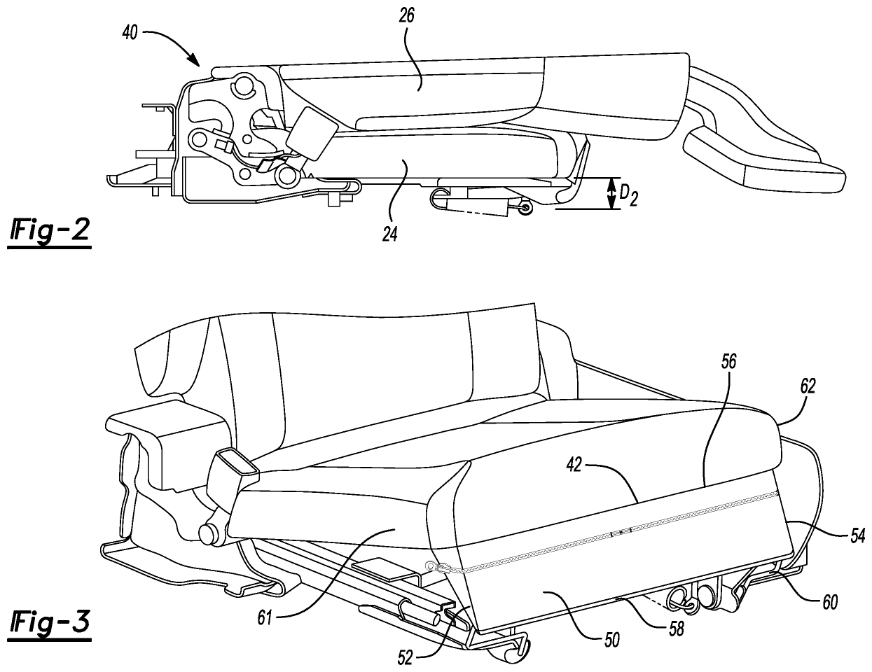

Referring to FIGS. 1 and 2, the seat back 26 may be pivotably attached to the seat bottom 24 by a recline mechanism(s) 40 allowing the seat back 26 to be placed at various angles in both the reclined and forward directions. The seat assembly 20 may include additional mechanisms (not visible) allowing the seat bottom 24 to be moved up and down relative to the floor via the linkages 29 and associated componentry. These mechanisms may be manually operated or may be electronically operated.

The seat assembly 20 may include one or more in-use positions and one or more non-use (stowed) positions. As shown in FIG. 1, the seat back 26 is generally upright when in the in-use position(s) and is folded forward over the seat bottom 24 when in the stowed position (FIG. 2). The recline mechanism 40 allows the seat back 26 to be reclined rearward of the upright position at various reclined angles based on the occupants preferred seating position. The seat back 26 is pivoted forward to extend over the seat bottom 24 when the seat assembly 20 is in the stowed position. In some embodiments, the seat back 26 may be substantially parallel to the seat bottom 24 when in the stowed position so that the backside of the seat back provides a flat storage structure. The seat bottom 24 may folded downwardly towards the floor when in the stowed position. For example, a bottom front edge 42 of the seat bottom 24 may be spaced above the floor by a distance D₁ when the seat assembly 20 is in the in-use position, and, when in the stowed position, the front bottom edge 42 may be spaced above the floor by a smaller distance D₂.

Referring back to FIG. 1, the seat bottom 24 is elevated relative to the rails 21 of the seat frame 22 whereby a gap 44 is formed under the front seat bottom 24. The gap 44 may be defined between the bottom front edge 42 of the trim cover 32 and the rails 21, which may generally coincide with the floor. The gap 44 provides a viewing window of the frame 22 and other components located underneath the seat bottom 24, which may be visible at least when the seat assembly 20 is in the in-use position. These components may not be aesthetically pleasing. Therefore, the aesthetics of the seat assembly 20 can be improved by concealing the gap 44.

Referring to FIGS. 1 and 3, a flap 50 may be attached on the front side of the seat bottom 24 to conceal the gap 44. The flap 50 may be generally rectangular having a left edge 52, a right edge 54, upper edge 56 extending from the left edge 52 to the right edge 54, and a lower edge 58 extending from the left edge 52 to the right edge 54. The upper edge 56 may be connected to the bottom front edge 42 of the trim cover 32 and lower edge 58 may be connected to a portion of the frame 22, such as a flap anchor 60. The flap 50 may extend the entire width of the seat bottom, i.e., from a left side 61 to a right side 62.

The flap 50 may be flexible sheet of fabric, leather, textile, spandex or the like. The flap 50 may be a stretchy material, e.g., spandex, other material with elastomeric fibers, or the like. The flap 50 may be formed of a different material than the trim cover 32. Alternatively, the flap 50 may be formed of the same material or same class of materials as the trim cover 32.

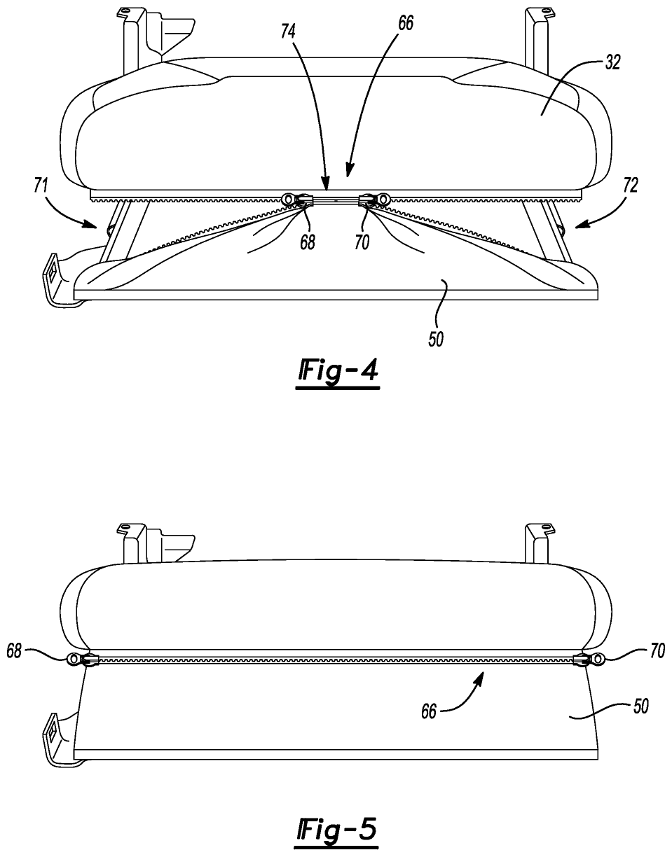

Referring to FIGS. 4 and 5, the flap 50 may be releasably connected to the front bottom edge 42 of the trim cover 32 by a lengthwise slide fastener 66, e.g., a zipper. The lengthwise slide fastener 66 may extend the entire width of the flap 50. The lengthwise slide fastener 66 may include a single slider or a pair of sliders 68, 70 as shown in FIG. 4. The pair of sliders 68, 70 may be oriented in opposite directions to allow the side portions 71, 72 of the flap 50 to be detached from the trim cover 32 while a middle portion 74 remains attached. The detachable side portions 71, 72 provide clearance to access the mounting bolts (or other fastener or connector) of the seat assembly. Providing the pair of sliders 68, 70 allows for the middle portion 74 of the flap 50 to remain attached when installing and removing the mounting bolts (or the like) without detachment of the slide fastener 66. The lengthwise slide fastener 66 is merely one example connection for the flap 50. Other examples include snaps, ties, hook-and-loop fastener, buttons, stitching, glue, or the like.

Referring back to FIG. 1, the seat anchor 60 may be an elongate member such as a metal rod with a circular cross-section. The seat anchor 60 may have a first end 80 attached to the left rail 21, a second and 82 attached to the right rail 23, and an intermediate portion 84 disposed between the ends. The seat anchor 60 may be bent to extend outwardly from the first and second ends 80, 82 to increase the width of the intermediate portion 84 to substantially match the width of the seat bottom 24.

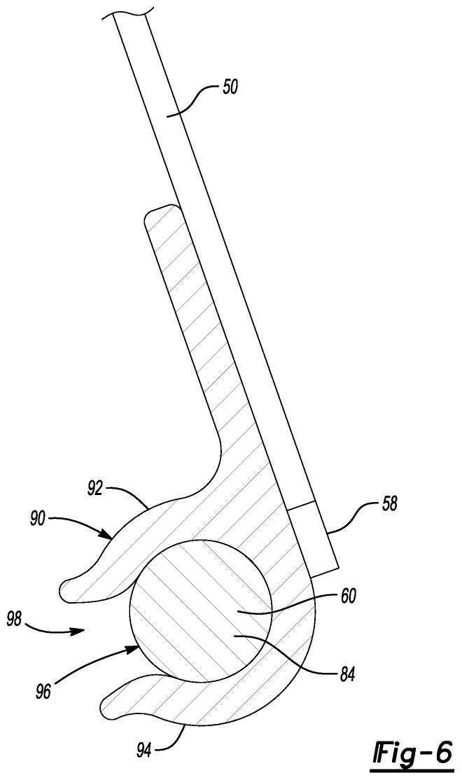

Referring to FIG. 6, a retainer 90 is provided at the lower edge 58 of the flap 50. The retainer 90 may be a single retainer that extends the length (or most of the length) of the lower edge 58 or may be a plurality of retainers 90 that are spaced along the length of the lower edge 58. The retainer 90 is configured to connect with the anchor 60. The anchor 60 and the retainer 90 cooperate to connect the flap 50 to the seat frame 22. The retainer 90 may be attached to the flap 50 by stitching, adhesive, mechanical fasteners, or the like. The retainer 90 may comprise a pair of resilient walls 92, 94 defining a cylindrical interior 96 and a slot 98. The slot 98 creates an entrance into the cylindrical interior 96. The retainer 90 is connected to the anchor 60 by inserting the intermediate portion 84 through the slot 98 and into the cylindrical interior 96. The resilient walls 92, 94 are configured to bend outwardly while the anchor 60 is received through the slot 98 and to spring back once the anchor 60 is fully received within the cylindrical interior 96, i.e., the retainer 90 is snap-fit or click-fit onto the anchor 60. The ends of the resilient walls 92, 94 may flare outwardly to increase the width of the entrance to facilitate insertion of the intermediate portion 84.

Rather than providing a retainer 90 configured to disconnect with the anchor 60, the flap may be removably attached to the anchor 60 using other mechanisms such as clips, snap, ties, hook-and-loop fastener, or the like. The flap may also be non-removably attached to the anchor 60. For example, the flap 50 may include a sleeve that receives the anchor 60 therethrough. In another example, the flap may be bonded to the anchor 60.

Referring to FIGS. 2 and 5, the flap 50 may be taut or tensioned when in the in-use position and may be not tensioned when in the stowed position. As depicted in FIG. 2, the anchor 60 may be above the lower front edge 42 of the trim cover 32 resulting in folding of the flap 50 when the seat is in the stowed position. In one or more embodiments, the resting or natural height of the flap 50 (measured between the top 56 and bottom 58) may be less than the distance between the anchor 60 and the bottom edge 42 when the seat is in the in-use position. This results in stretching of the flap 50, which is accommodated by the flexible or stretchable material of the flap 50. This tensioning of the flap 50 reduces wrinkles and may improve aesthetics of the flap 50.

Clause 1. An assembly comprising a trim cover sized to be received on a seat cushion, whereby a gap is defined between a bottom front edge of the trim cover and a seat frame. The assembly further comprising a flap comprising an upper edge connected to the trim cover and a lower edge connectable to the seat frame, the flap concealing the gap, wherein the flap is flexible such that the flap covers the gap when the seat cushion moves between an in-use position and a stowed position.

Clause 2. The assembly of clause 1, wherein at least a portion of the flap is releasably connected to the trim cover.

Clause 3. The assembly of clause 1 or 2, wherein the flap spans a width of the bottom front edge of the seat cushion.

Clause 4. The assembly of any of the proceeding clauses, wherein the upper edge is connected to the trim cover by a lengthwise slide fastener.

Clause 5. The assembly of clause 4, wherein the lengthwise slide fastener includes a pair of sliders.

Clause 6. The assembly of clause 5, wherein the pair of sliders are oriented in opposite directions.

Clause 7. The assembly of clause 4, wherein the lengthwise slide fastener extends along a width of the flap.

Clause 8. The assembly of any of the preceding clauses, wherein the lower edge of the flap comprises a retainer connectable to a flap anchor.

Clause 9. The assembly of clause 8, wherein the retainer comprises a pair of resilient walls defining a cylindrical interior and a slot configured to receive the flap anchor.

Clause 10. The assembly of clause 8, wherein the retainer extends an entire width of the lower edge.

Clause 11. The assembly of any of the preceding clauses, wherein the flap is formed of a different material than the trim cover.

Clause 12. An assembly comprising a trim cover received on a seat cushion, the seat cushion movable between a first position in which a gap below a front bottom edge of the trim cover has a first height and a second position in which the gap has a second height less than the first height; and a flap comprising an upper edge connected to the trim cover and a lower edge connected to a flap anchor, the flap concealing the gap, wherein the flap is tensioned when in the first position and is folded when in the second position.

Clause 13. The assembly of clause 12 further comprising a seat frame supporting the seat cushion, wherein the flap anchor is connected to the seat frame.

Clause 14. The assembly of clause 12 or 13, wherein the flap anchor comprises an elongate member, and wherein the flap further comprises a retainer connectable to the elongate member.

Clause 15. The assembly of clause 12 or 13, wherein the flap is releasably connected to the trim cover.

Clause 16. The assembly of clause 15, wherein at least a portion of the flap is releasably connected to the trim cover by a lengthwise slide fastener.

Clause 17. An assembly comprising: a frame comprising a pair of longitudinal rails, a seat pan, and a flap anchor disposed below the seat pan; a seat cushion disposed on the seat pan; and a trim cover received on the seat cushion, wherein a gap is defined between a bottom front edge of the trim cover and the flap anchor, wherein the seat pan is movable relative to the flap anchor between an in-use position in which the gap has a first height and a stowed position in which the gap has a second height less than the first height. The assembly further comprising a flap comprising an upper edge connected to the trim cover and a lower edge connected to the flap anchor, the flap concealing the gap, wherein the flap is tensioned when in the in-use position.

Clause 18. The assembly of clause 17 further comprising a lengthwise slide fastener connecting the upper edge of the flap to the trim cover.

Clause 19. The assembly of clause 17 or 18, wherein the flap is formed of a material having elastomeric fibers.

Clause 20. The assembly of clauses 17, 18, and/or 19, wherein the flap anchor comprises an elongate member having a first end attached to one of the rails, a second end attached to the other of the rails, and an intermediate portion, wherein the flap further comprises a retainer located on the lower edge and connectable to the intermediate portion.

While exemplary embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, the features of various implementing embodiments may be combined to form further embodiments according to the disclosure.

What is claimed is:

1. An assembly comprising:
a trim cover sized to be received on a seat cushion, whereby a gap is defined between a bottom front edge of the trim cover and a seat frame; and
a flap comprising an upper edge connected to the trim cover and a lower edge connectable to the seat frame, the flap concealing the gap,
wherein the flap is flexible such that the flap covers the gap when the seat cushion moves between an in-use position and a stowed position.

2. The assembly of claim 1, wherein at least a portion of the flap is releasably connected to the trim cover.

3. The assembly of claim 1, wherein the flap spans a width of the bottom front edge of the seat cushion.

4. The assembly of claim 1, wherein the upper edge is connected to the trim cover by a lengthwise slide fastener.

5. The assembly of claim 4, wherein the lengthwise slide fastener includes a pair of sliders.

6. The assembly of claim 5, wherein the pair of sliders are oriented in opposite directions.

7. The assembly of claim 4, wherein the lengthwise slide fastener extends along a width of the flap.

8. The assembly of claim 1, wherein the lower edge of the flap comprises a retainer connectable to a flap anchor.

9. The assembly of claim 8, wherein the retainer comprises a pair of resilient walls defining a cylindrical interior and a slot configured to receive the flap anchor.

10. The assembly of claim 8, wherein the retainer extends an entire width of the lower edge.

11. The assembly of claim 1, wherein the flap is formed of a different material than the trim cover.

12. An assembly comprising:
a trim cover received on a seat cushion, the seat cushion movable between a first position in which a gap below a front bottom edge of the trim cover has a first height and a second position in which the gap has a second height less than the first height; and
a flap comprising an upper edge connected to the trim cover and a lower edge connected to a flap anchor, the flap concealing the gap, wherein the flap is tensioned when in the first position and is folded when in the second position.

13. The assembly of claim 12 further comprising a seat frame supporting the seat cushion, wherein the flap anchor is connected to the seat frame.

14. The assembly of claim 12, wherein the flap anchor comprises an elongate member, and wherein the flap further comprises a retainer connectable to the elongate member.

15. The assembly of claim 12, wherein the flap is releasably connected to the trim cover.

16. The assembly of claim 15, wherein at least a portion of the flap is releasably connected to the trim cover by a lengthwise slide fastener.

17. An assembly comprising:
a frame comprising a pair of longitudinal rails, a seat pan, and a flap anchor disposed below the seat pan;
a seat cushion disposed on the seat pan;
a trim cover received on the seat cushion, wherein a gap is defined between a bottom front edge of the trim cover and the flap anchor, wherein the seat pan is movable relative to the flap anchor between an in-use position in which the gap has a first height and a stowed position in which the gap has a second height less than the first height; and
a flap comprising an upper edge connected to the trim cover and a lower edge connected to the flap anchor, the flap concealing the gap, wherein the flap is tensioned when in the in-use position.

18. The assembly of claim 17 further comprising a lengthwise slide fastener connecting the upper edge of the flap to the trim cover.

19. The assembly of claim 17, wherein the flap is formed of a material having elastomeric fibers.

20. The assembly of claim 17, wherein the flap anchor comprises an elongate member having a first end attached to one of the rails, a second end attached to the other of the rails, and an intermediate portion, wherein the flap further comprises a retainer located on the lower edge and connectable to the intermediate portion.
